(19) United States
(12) Patent Application Publication
(10) Pub. No.: US 2010/0044458 A1
(43) Pub. Date: Feb. 25, 2010

(54) Fragrance Dispensing Device

(76) Inventor: Erez Zabari, Rehovot (IL)

Correspondence Address: Avia Kafri, 22Shderot Chen St, Tel Aviv, 64166, IL

(21) Appl. No.: 11/992,297

(22) PCT Filed: Sep. 21, 2006
(86) PCT No.: PCT/IL2006/001115

§ 371 Date: Mar. 20, 2008

(30) Foreign Application Priority Data
Sep. 22, 2005 (IL) 171035

(51) Int. Cl. B05B 17/00

(52) U.S. Cl. 239/34

(57) ABSTRACT

Fragrance dispensing device providing for an artistic display combining visual and olfactory appealing elements is disclosed. The display is related to evolving processes, such as natural unfolding, growing, flowering, or fruit maturation, or changing a status of an object such as by moving a doll or a toy modeling a car, or by setting it into motion, simultaneously effected with fragrance dispensing. The fragrance dispensing device has at least one evolving artifact capable of changing from a state of standby into displaying and back to standby, a reservoir of perfume and a control unit. Activating a display is accomplished manually by means of an on/off switch, or a remote control unit; detecting an illuminating light by means of a light detector; detecting moving object such as human motion by means of a movement sensor; or preferably by interpreting sounds by means of an audio receiver.

### FIELD OF THE INVENTION

The present invention relates in general to scent diffusers and dispersal devices. In particular the present invention relates to devices providing artistic displays combining visual and olfactory appealing elements.

### BACKGROUND OF THE INVENTION

Fragrance dispensing systems are known in the marketplace. UK patent application GB 02350793A discloses a device for dispensing fragrance in conjunction with sounding an audible message or a pre-recorded sound. The disclosed device consists of a prerecorded sound chip, power cell and fragrance pad, is activated by means of an operating switch and is suitable for retaining fragrance air in a confined environment.

Japanese patent application JP2004260764A2 discloses a system for effectively transmitting information by sensing an audio signal and generating a fragrance. The system consists of an audio receiving unit and a unit for discharging fragrance. When a signal embedded in a received audio transmission matches a specific signal for generating a fragrance, a fixed quantity of fragrance is discharged from a fragrance-discharging unit.

### BRIEF DESCRIPTION OF THE DRAWINGS

FIG. 1 is a scheme of a sound activated fragrance dispensing device (SAFDD) according to a preferred embodiment of the present invention;

FIG. 2 is an isometric view of an evolving artifact of the SAFDD shown in FIG. 1.

### DETAILED DESCRIPTION OF THE PRESENT INVENTION

The fragrance dispensing device in accordance with the present invention provides an artistic display combining visual and olfactory appealing elements. The system of the invention can be implemented as a part of an existing ornamental item, typically a flowerpot, in which the display is related to phenomena such as evolving processes, natural unfolding, growing, flowering, and or fruit maturation. Optionally changing a status of an object, such as by moving a doll or a toy modeling a car, or by setting it into motion, when simultaneously effected with fragrance dispensing implement a display in accordance with the present invention. Preferably commencing a display is automatically activated by sound. Other options include activating by pressing an operating switch, detecting light illuminating the object by means of a light detector operative in a specific range of wavelengths, detecting a human motion, such as by means of a motion sensor typically employed for security purposes, or by means of a remote control unit. A display ends automatically after a while, the system returns to a state of standby and is ready for further activation as is described infra.

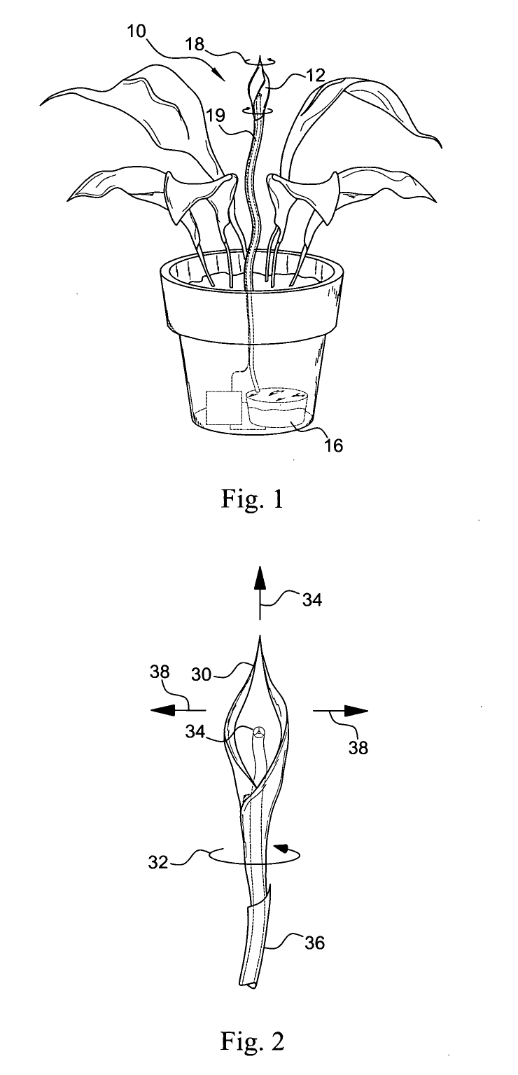

Reference is first made to FIG. 1 schematically showing a sound activated fragrance dispensing device (SAFDD) according to a preferred embodiment of the present invention. SAFDD consists of plant pot 10 carrying one or more evolving artifact 12. The evolving artifact 12 is engaged in either one of two states. When the system is at a state of standby the evolving artifact is contracted, and when the evolving artifact is operative in a display it is expanded and unfolded. In a preferred embodiment of the invention, the artifact is a bud evolving into a flower or an inflorescence. Issuing a sound, such as sounding a whistle, uttering a word, singing a tune, clapping hands and or snapping fingers, activates the SAFDD. Similarly playing a tune or sounding a noise of running water, are possible activating sounds according to the invention. Control unit 14 actuates the mechanical system as is described infra, to change the state of the evolving artifact 12 from a contracted state to an unfolded state, for example to transform it from a closed bud to an open flower, concomitantly with dispensing a perfume out of a perfume reservoir 16. Later, the evolving artifact returns to its retracted state. The retraction is brought about typically by mechanical actuation causing spiraling as described by arrow 18. Whereas the contraction is effected by mechanical actuation in the opposite direction as indicated by arrow 19, after which the evolving artifact is ready for reopening and further dispensing of perfume.

Reference is now made to FIG. 2 in which an isometric view of the evolving artifact described above is shown in more details. A rolled up elastic strap 30 is made to resemble a spathe of the arum family of plants, possibly vividly colored. The arrow 32 indicates the rolling. The rolling is associated with pushing of the folded sheet upwards, as is indicated by the arrow 34, out of tubular body 36. Spathe imitation is made of an elastic strap 30, which was initially spiraled and inserted into the lumen of tubular body 36. The wall of spathe imitation 30, when forced out of pipe 36 is made to unfold due to the elastic restoring forces exerted by the spiraled strap, and is expanded in the direction of the arrows 38. A simple linear actuator push-pulling movement implements the spiraled movement of the elastic strap. Alternatively spiraling movements are effected by means of rotating a screw into a nut connected to the end of the spathe imitation hidden within the pipe implementing the stem. Such rotations in opposite directions raise or lower the spathe respectively. As a result an aperture located at the end of a capillary tube 40 is openly revealed. The other end of capillary tube 40, is connected to the outlet of the perfume reservoir through a corresponding valve, both are not shown.

The SAFDD and its evolving artifact are preferably made of colored fabrics or plastic sheets. The stem into which the evolving figure is mounted is made of a stiff colored plastic pipe. Optionally the stem leans over a supportive rod. The perfume reservoir can be any of the following, a container that can be refilled with, an aromatic liquid, a pad soaked with such liquid, or a volatile solid material that is vaporized by heating, implements. The dispensing of fragrance in cases in which aromatic liquids are utilized, is accomplished by initially pressurizing the container and then opening the outlet valve for a short while typically simultaneously with unfolding the evolving artifact. Alternatively, electrically heating the volatile aromatic solid and opening the outlet valve, effects fragrance dispensing in cases in which aromatic solids are utilized. Pressurizing is accomplished by means of a pump or by connecting the perfume container to a source of pressurized gas.

Optionally the activation of the evolving artifact and the fragrance dispensing is accomplished simply by on/off switching an electrical circuit, or by means of a remote control unit linked to the control unit of the fragrance dispensing device by means of electromagnetic radiation in the RF or the infrared ranges. Alternatively a light detector operative in a specific band of wavelengths within the range including the visible and infrared ranges; or a movement sensor, such as typically employed for security purposes; are employed to activate the display, when the intensity of illuminating light exceeds a predefined threshold, or a human motion is detected, respectively.

In a preferred embodiment of the present invention the control unit includes an audio receiver consisting of a microphone connected to an amplification and filtering electronic circuitry and mechanical actuating means for activating the evolving artifacts and/or the fragrance dispenser, such as by starting the pump and opening and closing the outlet valves.

1. A fragrance dispensing device having a perfume reservoir from which perfume is automatically dispensed, said fragrance dispensing device comprising
at least one evolving artifact capable of changing between a first state which is a standby state and a second state in which said evolving artifact is operative in an artistic display;
a control unit for controlling said changing, and
wherein said artistic display combines any appealing element selected from a group of appealing elements consisting of visual elements, auditory elements, olfactory elements and any combination thereof.

2. A fragrance dispensing device as in claim 1, wherein said evolving artifact is contracted at said first state, and wherein at the second state said evolving artifact is expanded;

3. A fragrance dispensing device as in claim 1, wherein said control unit comprises any member selected from a group of members consisting of operating switches, remote control units, light detectors, movement sensors and any combination thereof, and wherein said light detectors are operative in a band of wavelengths within the range including visible and infrared light.

4. A fragrance dispensing device as in claim 1, wherein said control unit comprises an audio receiver for interpreting at least some sounds as activating signals for at least said fragrance dispensing, and wherein said sound is selected from a group of sounds consisting of uttering at least an utterance, singing, playing a tune, hand clapping, finger snapping, running water, whistling and any combination thereof.

5. A fragrance dispensing device as in claim 4, wherein said audio receiver interprets at least some sounds as activating signals for both said fragrance dispensing and said changing.
